(19) United States
(12) Patent Application Publication
(10) Pub. No.: US 2023/0358712 A1
(43) Pub. Date: Nov. 9, 2023

(54) METHOD FOR MANUFACTURING A MULTI-CAPILLARY LINING

(71) Applicant: SEPARATIVE, Solaize (FR)

(72) Inventor: François Parmentier, St Martin D'Heres (FR)

(21) Appl. No.: 18/003,805

(22) PCT Filed: Jul. 5, 2021
(86) PCT No.: PCT/FR2021/051235

§ 371 Date: Jul. 26, 2023

(30) Foreign Application Priority Data
Jul. 3, 2020 (FR) 2007106

(51) Int. Cl. G01N 30/56; G01N 30/60; B01J 20/30

(52) U.S. Cl. CPC G01N 30/56; G01N 30/6078; B01J 20/3078; G01N 2030/562

(57) ABSTRACT

The present disclosure relates to a method for manufacturing multi-capillary lining that can serve as a chromatographic column, and to the multi-capillary packing obtained by such a method.

### FIELD OF THE INVENTION

The invention relates to a method for manufacturing a multi-capillary packing that can act as a chromatography column and the multi-capillary packing obtained by such a method.

### BACKGROUND OF THE INVENTION

Packings used in chromatography are generally composed of a monolithic porous mass, typically consisting of a silica or alumina gel and a multitude of substantially straight channels or conduits, parallel to one another and extending through this porous mass.

Various methods are known for preparing multi-capillary packings that can be used in chromatography.

For example, it is known that multi-capillary packings can be prepared from ablative preforms, for example fibres assembled into a bundle, which are eliminated after formation of a porous matrix around the fibres (WO2013/064754), the assembly forming a monolithic structure. The porous matrix can, in particular, be prepared by a sol-gel method and consist of silica, alumina or an aluminosilicate. The ablation of preforms by combustion or pyrolysis generates conduits in the mineral matrix.

The preparation of these packings proves difficult due to the finest of the conduits required for certain applications and the difficulty of producing monoliths without inherent defects, in other words without cracks or fissures.

Thus, there is a need to provide a method for preparing a multi-capillary packing, allowing the mentioned disadvantages to be overcome, in particular minimising the risk of cracks and fissures.

### BRIEF DESCRIPTION OF THE INVENTION

The present invention relates to a method for manufacturing a multi-capillary packing from a substrate of ablative preforms, each preform being suitable for forming, during its ablation, a conduit enabling the convection of a fluid in said packing. The method comprises the following steps:
(a) assembling the ablative preforms in the form of at least one bundle;
(b) creating a gel between the ablative preforms of the bundle by hydrolysis of an organometallic precursor in the presence of a quantity of water not exceeding ten times the stoichiometric quantity required for complete hydrolysis of said organometallic precursor;
(c) ablating the preforms, preferably by pyrolysis, oxidation, vaporisation, melting and drainage, mechanical extraction or chemical attack, so as to form a plurality of conduits in the gel.

The present invention also relates to a multi-capillary packing which can be obtained by the method of the invention.

Other aspects of the invention are as described in the claims and below.

### DETAILED DESCRIPTION OF THE INVENTION

The inventor has developed a method for manufacturing a multi-capillary packing from ablative preforms conforming to the expressed needs.

The method of the present invention comprises the following steps:
(a) assembling the ablative preforms in the form of at least one bundle;
(b) creating a gel between the ablative preforms of the bundle, comprising hydrolysis of an organometallic precursor in the presence of a quantity of water not exceeding ten times, preferably not exceeding five times, the stoichiometric quantity required for complete hydrolysis of said organometallic precursor;
(c) ablating the preforms by pyrolysis, preferably by oxidation, vaporisation, melting and drainage, mechanical extraction or chemical attack, so as to form a plurality of conduits in the gel.

Here “stoichiometric quantity of water required for complete hydrolysis” means the quantity of water required in order to convert all of the hydrolysable groups of the organometallic precursor into M-O-M bonds (M designates the metal of the organometallic precursor).

In the case where M is a silicon atom, in particular and in a non-limiting manner, M-O—R, M-N—R, M-S—R, M-O—B bonds, where R is an organic group, of the organometallic precursor are considered to be hydrolysable.

In the case where M is a silicon atom, in particular and in a non-limiting manner, the M-C-bonds are generally considered to be non-hydrolysable. It is noted however that the addition of substituents or heteroatoms, such as O, N, S, etc. on the carbon C can make these M-C bonds fragile. In this latter case, the bonds are considered to be hydrolysable.

Thus, for example, for one mole of tetraalkoxysilane of formula M(OR)₄ with M=Si, OR being the alkoxy radical, R being an alkyl, for example a methyl or ethyl group, the stoichiometric quantity of water required is two moles/mole of tetraalkoxysilane:

Si(OR)₄+2H₂O->SiO₂+4ROH

Thus, for example, for one mole of trialkoxysilane of formula R′M(OR)₃ with M=Si, OR being the alkoxy radical, R being an alkyl, for example a methyl or ethyl group, R′ being for example an alkyl, for example a methyl or ethyl group, the stoichiometric quantity of water required is 1.5 moles/mole of trialkoxysilane.

Thus for example, for one mole of dialkoxysilane of formula R′R″M (OR)₂ with M=Si, OR being the alkoxy radical, R being an alkyl, for example a methyl or ethyl group, R′ being an alkyl, for example a methyl or ethyl group, R″ being an alkyl, for example a methyl or ethyl group, the stoichiometric quantity of water required is one mole/mole of dialkoxysilane.

It should be noted that the molecules of water generated during the hydrolysis and coupling reaction are taken into consideration in the determination of the stoichiometric quantity of water required for complete hydrolysis of said organometallic precursor.

Thus, in all these estimates, account is taken of the fact that the silanol groups, resulting from the hydrolysis and present on the silicon, couple two-by-two to form siloxane bridges in order to form the silica gel, a reaction which itself restores one water molecule to the reaction medium per siloxane bridge created.

R′ and R″ can likewise advantageously be the radicals dodecyl, octadecyl, n-octyl, n-propyl, n-butyl, vinyl, 3-chloropropyl, 3-aminopropyl, 2-aminoethyl-3-aminopropyl, 3-aminopropyl, 3-ureidopropyl, 3-glycidoxypropyl, 3-glycidoxypropyl, 3-methacryloxypropyl, bis(propyl)tetrasulfide, bis(propyl)disulfide, 3-mercaptopropyl, trifluoropropyl, containing epoxy bonds, etc. O—R can advantageously be an alkoxy radical (e.g. methoxy, ethoxy), acyloxy, acetoxy, ketoxime, methylethylketoxime, oximino, etc. (O—R)₄, (O—R)₃, (O—R)₂, can themselves respectively represent 4, 3, or 2 R groups listed above, all identical or different.

The ablative preforms are typically suitable for forming, during their destruction or elimination, axial conduits that are substantially straight and parallel to one another, enabling the convection of a fluid (e.g. mobile phase) between an input face of the packing and an output face of the packing. Preferably, the ablative preforms are in the form of fibres or yarns.

The ablative preforms consist of, in particular are composed of, materials such as carbon (e.g. carbon fibres), polyester, polyamide, polyolefins (e.g. polypropylene, polyethylene), polyacrylate, polymethacrylate, polysulfones, polyurethanes, polyimide, polyether, for example biodegradable polymers (e.g. polydioxanone, polyglycolic acid, polylactic acid). The ablative preforms can be fusible yarns, for example yarns comprising indium, bismuth, tin, gallium, silver or the alloys thereof with other metals, preferably excluding lead, mercury and cadmium.

Thus, in certain embodiments, the preforms comprise yarns of polyamide, polyolefin, polyacrylate, polymethacrylate, polysulfone, polyurethane, polyimide, polyether or polyester yarns.

The ablative preforms can consist of fibres which may or may not be hollow or porous. The fibres cross-section is circular, but optionally non-circular, such as square, rectangular, hexagonal, polygonal cross-sections, or is in film form. This list is not limiting.

The ablative preforms preferably have a cross-section between several tenths of a square micrometre and several square micrometres.

The diameter of the preforms will preferably be less than 250 μm, advantageously less than 100 μm and more advantageously less than 5 μm.

The diameter considered will be the hydraulic diameter measured perpendicular to the mean direction of flow of the fluid in the packing.

The definition of the hydraulic diameter d is as follows:

$$d = \frac{4 A}{P}$$

where A is the area of the cross-section of passage of the tube and P is the wetted perimeter of this cross-section.

In certain embodiments, the ablative preforms can extend linearly and without interruption between an inlet face and an outlet face of the material.

In other embodiments, the ablative preforms conform with or extend into only a portion of the material and are immersed or occluded therein. Thus, in certain embodiments, the preforms can be in the form of segments occluded in the body of the packing.

In these embodiments, a compact stack of ablative preforms is produced in the material in order to promote, in the final packing, the convective transfer of a fluid circulating in the material between the conduits and towards an outlet face.

In all cases, the permeability of the material is thus increased with respect to a circulating fluid.

Advantageously, the ablative preforms have dimensions that are as uniform as possible. The preforms can be characterised by at least two dimensions:
1. the diameter or hydraulic diameter of the preforms; and
2. the length of the preforms.

Advantageously, the diameter or hydraulic diameter has a variability characterised by its relative standard deviation of less than 30%, preferably less than 10%, yet more preferably less than 2% of the average diameter of the preforms.

Advantageously, the length has a variability characterised by its relative standard deviation of less than 30%, preferably less than 10%, yet more preferably less than 2% of the average length of the preforms.

In certain embodiments, the ablative preforms are covered with a porous granular substance, for example microbeads of silica or glass, a silica gel, an alumina gel, a titanium gel or a zirconium oxide gel. This layer of porous granular substance can have at least two purposes: it avoids contact between the abrasive forms, the porous granular substance acting as a spacer, and it can provide an inherent functionality to the material (for example a reactive functionality or a catalytic role).

The pores of the granular substance can be closed by a third body. This third body is preferably a pyrolysable organic solid, soluble in a solvent or volatile, for example a paraffin. Advantageously, this third body can be eliminated in the remainder of the method (for example before or after elimination of the ablative forms or concomitantly with this ablation) and is not found in the final product.

The preforms, assembled in bundle form, are held together by means of a gel acting as a binder, in order to give a monolithic structure.

The gel can be based on any mineral compound leading to a cohesion of the monolith. Thus, the gel can be a gel based on aluminium oxide, silicon oxide, zirconium oxide, titanium oxide, the oxide of a rare earth such as yttrium, cerium or lanthanum, boron oxide, iron oxide, magnesium oxide, calcium oxide, strontium oxide, barium oxide, germanium oxide, phosphorus oxide, lithium oxide, potassium oxide, sodium oxide, niobium oxide, copper oxide or one of the mixtures thereof.

In certain embodiments, the gel is a gel based on silicon oxide (silica gel) or aluminium oxide (alumina gel).

In certain embodiments, the gel is a gel based on zirconium oxide or titanium oxide.

In certain embodiments, the gel is a multi-component oxide gel. For example, the gel can consist of binary oxides of zirconium and yttrium, zirconium and cerium, zirconium and calcium, barium and titanium, lithium and niobium, phosphorus and sodium or boron and lithium. The gel can be a gel consisting of silicate, for example binary silicates based on silica and boron oxide, aluminium oxide, germanium oxide, titanium oxide, zirconium oxide, strontium oxide or iron oxide, ternary silicates, multi-component silicates comprising more than three constituents. In certain embodiments, the gel is a multi-component oxide gel, for example an aluminosilicate gel, for example a clay.

The gel is prepared in situ by the well-known so-called sol-gel (“solution-gelation”) process.

The gel is then typically created by immersion of the one or more bundles of preforms in a sol precursor of a gel which is then treated in such a way as to form a gel. The sol is typically poured on the preforms disposed in a mould or in a tube.

According to another embodiment, the preforms are added to the sol, and the mixture is poured into a mould or a tube.

Here, “sol” means any mixture comprising an organometallic precursor, and advantageously water in a quantity not exceeding ten times the stoichiometric quantity required for a complete hydrolysis of said organometallic precursor.

In the context of the present invention, the gel is created between the preforms by hydrolysis of an organometallic precursor. The organometallic precursor comprises at least one, in particular at least two, hydroxyl groups or hydrolysable groups for forming metal oxides during their hydrolysis. Thus, the organometallic precursor is typically an organometallic alkaloid, an organometallic acetate, an organometallic carboxylate, an organometallic halide, an organometallic nitrate, an organometallic alkanoate or an organometallic acyloxide.

Examples of organometallic precursors include, in a non-limiting manner, tetrachlorosilane, aluminium nitrate (which can be hydrolysed in the presence of urea), tetramethoxysilane, tetraethoxysilane, diethyl(dimethoxy)silane, triethyl(methoxy)silane.

The organometallic precursor is preferably an organometallic alkaloid.

The hydrolysis of the one or more organometallic precursors is carried out in an aqueous medium. The aqueous medium can comprise exclusively water or can comprise a mixture of water and an organic solvent, for example methanol or ethanol, in order to make the mixture homogeneous. The quantity of organic solvent is typically less than 12 times the volume of the organometallic precursor, preferable 4 times less than this volume, still more preferably 2 times less than this volume, and in particular less than 0.5 times this volume. In certain embodiments, the organometallic precursor is placed in the water under agitation until a homogeneous mixture is formed by partial hydrolysis of the precursor.

It has been shown that when the gel is created by hydrolysis of an organometallic precursor in the presence of a quantity of water not exceeding ten times or six times, or five times, preferably not exceeding four times, still more preferably not exceeding two times, or even 1.25 times the stoichiometric quantity (molar stoichiometric quantity) required for complete hydrolysis of said organometallic precursor, the multi-capillary packing/monolithic structure obtained by the method of the present invention has a minimum of cracks, fissures and defects. In certain embodiments, the hydrolysis of the organometallic precursor is carried out in the presence of a quantity of water substantially equal to, or equal to, the stoichiometric quantity (molar stoichiometric quantity) required for complete hydrolysis of said organometallic precursor. In certain embodiments, the hydrolysis of the organometallic precursor is carried out in the presence of a quantity of water not attaining the stoichiometric quantity (molar stoichiometric quantity) required for complete hydrolysis of said organometallic precursor, for example the quantity of water can be half of the stoichiometric quantity (molar stoichiometric quantity) required for complete hydrolysis of said organometallic precursor. Thus, the hydrolysis of the organometallic precursor can be carried out in the presence of a quantity of water varying from 0.5 times to 10 times or from 0.5 to 5 times the stoichiometric quantity (molar stoichiometric quantity) required for complete hydrolysis of said organometallic precursor.

The hydrolysis step is typically catalysed by an acid or a base. The choice of an acid or base catalyst typically depends on the precursor or precursors used.

Advantageously, in the case where the metallic part of the organometallic precursor consists of one or more silicon atoms, a series of catalyses can be carried out: for example a first acid hydrolysis can be carried out preferably before insertion of the sol between the preforms of the conduits (i.e., before immersion of the ablative preforms of the bundle in the sol), followed by addition of a base resulting in a hydrolysis in base medium of the sol between the preforms of the conduits.

In certain embodiments, the gel is created by hydrolysis of an organometallic precursor chosen from the organometallic derivatives of silicon, aluminium, zirconium, titanium, a rare earth such as yttrium, cerium or lanthanum, boron, iron, magnesium, calcium, strontium, barium, germanium, phosphorus, lithium, potassium, sodium, niobium, copper, or one of the mixtures thereof, preferably silicon, zirconium or titanium. The mixtures can be binary, ternary or may even comprise more than three organometallic derivatives.

In certain embodiments, the gel is created by hydrolysis of one or more organometallic precursors which can be as described above in the presence of one or more metal salts, for example nitrates or chlorides.

The choice of the one or more organometallic precursors will depend on the nature of the desired packing. For a chromatography application, the organometallic precursors will advantageously be chosen in such a way as to give a gel that is as cohesive and rigid as possible. The gel will be as dense as possible in order to have the highest possible specific surface area per unit volume of the material and for a given pore size.

Thus, in other words, step b) of creating a gel can be advantageously worded in the following manner:
(b1) preparing a sol comprising an organometallic precursor as described above;
(b2) immersing the ablative preforms of the bundle in the sol;
(c2) hydrolysis of the organometallic precursor in the presence of a quantity of water not exceeding ten times or five times the stoichiometric quantity required for complete hydrolysis of said organometallic precursor in such a way as to create a gel.

Once the gel is formed, the preforms can be collapsed, advantageously by pyrolysis, oxidation, vaporisation, melting and drainage, mechanical extraction or chemical attack.

After destruction or elimination of the preforms, only the gel traversed by the conduits remains.

Optionally, a plurality of collapsing or ablation steps are implemented, such as a first hydrolysis step followed by a pyrolysis step.

Optionally, this ablative step can be completed or combined with part of a heat treatment such as sintering in order to consolidate the network and the mechanical strength of the material. These heat treatments are known to a person skilled in the art.

Typically, for a silica gel, such a heat treatment can consist of annealing at temperatures advantageously between 650 and 850° C., for a time varying between several minutes or tens of minutes to several hours or tens of hours. For example, such a treatment could be carried out at 700° C. for 2 hours to 12 hours.

Optionally, this ablative step or this additional thermal annealing step can, in the case of a silica gel, be followed by a step of rehydroxylation of the surface of the gel, by a steam treatment, by a hydrothermal treatment or by a treatment in a basic or acidic aqueous medium for example, according to any technique known to a person skilled in the art. Indeed, it is known that high temperatures, greater than 170° C., but more particularly greater than 500° C., or even 700° C., promote dehydroxylation of the surface of the silica gel in a more or less reversible manner. Typically, a silica gel produced at ambient temperature and dried at 105° C. has between 8 and 4.5 silanol groups per nm². At 170° C., this population starts to decrease slowly, and reduces as the temperature of the treatment rises until leaving only 1 silanol group per nm² at approximately 700° C. This dehydroxylation can be harmful to the final application of the packing, modifying its absorption characteristics, the surface becoming less polar, altering its capacity to receive functional grafting, and making the surface unstable in the presence of water. A rehydroxylation may therefore be necessary in order to restore the functionality of the silica gel.

The gel is dried before after ablation of the preforms. The drying is carried out under conditions making it possible to ensure its structural and mechanical integrity as much as possible, in particular in such a way as to limit as much as possible the formation of fissures and macroscopic or microscopic shrinkage.

The drying can be carried out under vacuum or at atmospheric pressure, preferably at ambient temperature. The drying is typically carried out slowly at a controlled temperature and partial pressure. The drying time is typically at least one hour, or greater than ten hours, greater than 24 hours and can extend to several days. In certain embodiments, the drying time is 48 hours. The larger, in particular the thicker, the material to be dried, the longer will be the drying time. In certain embodiments, the drying is carried out at ambient temperature (20-25° C.) under vacuum at a pressure of 1 to 50 kPa for approximately 48 hours.

The slow drying technology advantageously makes it possible to obtain large-size packings having a large number of conduits. Thus, the method of the present invention makes it possible to prepare packings comprising more than a hundred conduits, or even more than a thousand conduits, or even more than ten thousand conduits.

The method of the present invention can make it possible to prepare packings having a cross-section greater than 0.1 cm², more advantageously greater than 1 cm², still more advantageously greater than 10 cm², or even greater than 100 cm².

In certain embodiments, the drying is carried out after a maturation making it possible to reinforce the structure of the gel and to increase the diameter of its pores. The maturation is typically carried out while keeping the gel at ambient temperature for a period of approximately 24 hours or greater than 24 hours.

In general, a silica gel typically has a specific surface area ranging from 20 to 1200 m²/g, preferably ranging from 20 to 700 m²/g, more preferably between 70 and 450 m²/g.

Silica gel typically has a pore volume ranging from 20% to 90% by volume of the gel, more advantageously ranging from 40% to 70%, or even 65% by volume of the gel. The term “volume of the gel” means the volume of gel between the conduits of the monolith delimited by its outer contour, separate from any spaces intended to keep open a passage to the fluid by maintaining a space between different masses or portions of silica gel, and outside the volume delimiting the contours of the spacers, i.e. the volume of the gel located between the conduits of the monolith. The optional spacers are not taken into account in determining the volume of the gel; in other words, in the case where spacers are present, the gel is considered to be located outside of the spacers.

Silica gel is generally produced in such a way as to obtain large-diameter pores. It is known that the capillary forces leading to the shrinking and cracking of the gel during its drying vary as the inverse of this diameter. The diameter of the pores of the gel before drying is typically greater than 4 nm, preferably greater than 10 nm and does not generally exceed 1000 nm.

The diameter of the pores of the gel after drying is typically greater than 2 nm, preferably greater than 10 nm and does not generally exceed 1000 nm.

In certain embodiments, the precursor sol of the silica gel comprises additives conventionally used for the preparation of packings. Thus, the sol may comprise surfactants or chemical additives to control drying such as formamide. This will reduce cracking during drying.

In certain embodiments, a solid filler can be added to the gel. The solid filler can mechanically reinforce the resulting gel, limit its shrinkage and optionally give the final gel an additional functionality, such as additional specific surface area or a catalytic functionality.

The solid filler can be silica gel powder or alumina gel powder. Advantageously this powder has a high specific surface area, advantageously greater than 250 m²/g, more advantageously greater than 450 m²/g, still more advantageously greater than 700 m²/g. Advantageously this powder has a very fine particle size, less than 25 μm, preferably less than 3 μm, more preferably less than 0.5 μm.

The solid filler can consist of fibres, microfibres or nanofibres, such as whiskers such as potassium titanate fibres. These are marketed, in particular, under the brand Tismo D. They give a greater rigidity to the final material.

The specific surface areas, pore sizes and pore volumes mentioned in this text are measured by nitrogen absorption using the BET method.

The packing obtained by the method of the present invention can then be pyrolysed at high temperature, for example at temperatures ranging from 300 to 700° C.

The packing obtained by the method of the present invention can be surface modified. Optionally, a silica gel packing according to the invention can be grafted using a functional silane, in order to modify its absorption and retention properties for a chromatographic application.

The functional silanes that can be used include, in a non-limiting manner, dodecyltrimethoxysilane, octadecyltrimethoxysilane, hexadecyltrimethoxysilane, methyltrimethoxysilane, n-octyltriethoxysilane, n-octyltrimethoxysilane, n-propyltrimethoxysilane, n-propyltriethoxysilane, methyltriacetoxysilane, ethyltriacetoxysilane, vinyltriacetoxysilane, vinyltri(2-methoxyethoxy)silane, 3-chloropropyltriethoxysilane, 3-chloropropyltrimethoxysilane, 3-chloropropylmethyldimethoxysilane, 3-aminopropyltriethoxysilane, 2-aminoethyl-3-aminopropyltrimethoxysilane, 3-aminopropyltrimethoxysilane, bis(trimethoxysilypropyl)amine, 3-ureidopropyltrimethoxysilane, 3-glycidoxypropyltrimethoxysilane, 3-glycidoxypropylmethyldimethoxysilane, 3-methacryloxypropyltrimethoxysilane, 3-methacryloxypropylmethyldimethoxysilane, bis(3-triethoxysilylpropyl)tetrasulfide, bis(3-triethoxysilylpropyl)disulfide, 3-mercaptopropyltrimethoxysilane, 3-mercaptopropylmethyldimethoxysilane, vinyltris(methylethylketoxime)silane, vinyl oximino silane, methyltris(methylethylketoxime)silane, methyl oximino silane, tetra(methylethylketoxime)silane, trifluoropropylmethyldimethoxylsilane, silanes containing epoxy bonds, etc.

### EXEMPLARY EMBODIMENTS

### First Embodiment

In certain embodiments, the material obtained, i.e. the gel, is mesoporous and preferably has no macroporosity. The gel differs, in particular, from the multimodal silica gels marketed by Merck under the trade name Chromolith, and derived from the research of K Nakanishi [1], [2], and N. Ishizuka [3].

Such gels are obtained by a standard sol gel method not involving spinodal decomposition. It is generally considered that the microporosity range comprises pores of diameter less than 2 nm, that the mesoporosity range comprises pores of diameter between 2 nm and 50 nm, and that the microporosity range comprises pores of diameter greater than 50 nm. However, here it is considered that the microporosity range comprises pores of diameter less than 2 nm, that the mesoporosity range comprises pores of diameter between 2 nm and 150 nm, and that the microporosity range comprises pores of diameter greater than 150 nm.

Therefore, the silica gel obtained has a volume fraction of macropores less than 50% of its total pore volume, more advantageously less than 25% of its total pore volume, still more advantageously less than 10% of its total pore volume.

Advantageously, the silica gel has a volume fraction of micropores less than 30% of its total pore volume, more advantageously less than 10% of its total pore volume, still more advantageously less than 5% of its total pore volume.

Advantageously, the silica gel has a volume fraction of mesopores greater than 30% of its total pore volume, more advantageously greater than 65% of its total pore volume, still more advantageously greater than 80% of its total pore volume.

The volume fractions of pores are determined by nitrogen absorption measurements using the method of Brunauer Emett and Teller, known as the BET method.

This measurement will be carried out over the porous region constituting the gel itself and excluding the volume of the conduits.

It has been shown that when a silica gel is created by hydrolysis of an organometallic precursor in the presence of a quantity of water not exceeding ten times, preferably not exceeding six times or not exceeding five times, still more preferably not exceeding four times, or even two times the stoichiometric quantity (molar stoichiometric quantity) required for complete hydrolysis of said organometallic precursor, the multi-capillary packing/the megalithic structure or silica gel obtained has a minimum of cracks, fissures and defects with a density of the gel, having for example a high silica density (typically 0.05 to 1.2 g/cm³, preferably between 0.1 and 0.8 g/cm³).

Advantageously, the density of the silica gel obtained by the hydrolysis method will be between 0.1 and 0.40 g/cm³. More advantageously, the density of the silica gel obtained by the hydrolysis method will be between 0.15 and 0.35 g/cm³.

This is the density range which results from the hydrolysis of the tetramethoxysilane or tetraethoxysilane with quantities of water between 1 and 10 times the stoichiometric quantity required, more particularly when the drying is a slow drying as currently described, this drying inducing a negligible shrinkage. This specification responds to the need for producing monoliths conforming to the dimensions of the preforms, without distortion or cracking or fragmentation of the final dried gel, and having a sufficient mechanical strength and as high a silica density as possible.

The density of the gel is an index of the possible use of the sol gel method for producing the multi-capillary material.

It is, moreover, noted that the density of the silica gel obtained is all the higher as R is of low molecular weight.

Preferably, in this first embodiment, the organometallic precursor of a silica gel is tetramethoxysilane. In this case, the theoretical density in the absence of any shrinkage by syneresis, drying, or heat treatment of the silica gel resulting from said method is between 0.18 and 0.32 g/cm³.

Preferably, in this first embodiment, if safety considerations prevail, tetraethoxysilane, which is less toxic and dangerous to handle, is used as the organometallic precursor of the silica gel. In this case, the theoretical density in the absence of any shrinkage by syneresis, drying, or heat treatment of the silica gel resulting from said method is between 0.15 and 0.25 g/cm³.

Here, “density of the silica gel” means the density of the gel resulting from the hydrolysis method, between the conduits of the monolith delimited by its outer contour and excluding the volume of the conduits, i.e. the density of the gel located between the conduits of the monolith.

The optional spacers are not taken into account in determining the density of the gel; in other words, in the case where spacers are present, the gel is considered to be located outside of the spacers.

On the other hand, if the silica gel contains third bodies such as fibres, microfibres, nanofibres, and particles or nanoparticles, the density considered is the density of the medium exterior to these third bodies and produced by the sol gel method itself.

The density may be measured using:
1. either porosimetry according to the BET method if the silica gel does not contain such third bodies;
2. or transmission electron microscopy followed by image analysis, on a section of the material if the silica gel contains such third bodies.

Advantageously, in this first embodiment, the conduits can extend linearly and without interruption between an inlet face and an outlet face of the material.

### Second Embodiment

In certain embodiments, the material obtained, i.e. the gel, is macroporous. In particular, it concerns multimodal silica gels of the type marketed by Merck under the trade name Chromolith, and derived from the research of Takanishi and Ishizuka [1], [2], [3] in Japan.

These gels are typically synthesised by spinodal decomposition of a silica gel by a sol gel method in the presence of a polymer such as, for example, polyvinyl alcohol, polyethylene glycol, etc. In this way, a three-dimensional macroporous silica skeleton is formed, for which the macropore sizes can reach several micrometres. The silica skeleton is itself mesoporous. A chromatographic mobile phase can percolate through the micropores, and interact with the surface of the silica gel of the mesopores.

These particular silica gels are referred to here by the term “multimodal gels”.

Advantageously, according to the invention, a multimodal silica gel is created by hydrolysis of an organometallic precursor in the presence of a quantity of water not exceeding six times, preferably not exceeding five times, more preferably not exceeding four times, or even two times the stoichiometric quantity (molar stoichiometric quantity) required for complete hydrolysis of said organometallic precursor. The multi-capillary packing/monolithic structure obtained by the method of the present invention then has a minimum of shrinkage at drying, a maximum compactness, cracks and defects with a density of the gel, and has for example a high silica density (typically 0.05 to 1.2 g/cm³, preferably between 0.1 and 0.8 g/cm³).

It is, moreover, noted that the density of the silica gel obtained is all the higher as R is of low molecular weight.

Preferably, in this embodiment leading to a multimodal silica gel, the organometallic precursor is tetramethoxysilane.

Preferably, if safety considerations prevail, the organometallic precursor of a multimodal silica gel is tetraethoxysilane, which is less toxic and less dangerous to handle.

Here, “density of the silica gel” means the density of the gel resulting from the hydrolysis method, between the conduits of the monolith delimited by its outer contour and excluding the volume of the conduits, i.e. the density of the gel, or of the part of the gel resulting from the hydrolysis method, located between the conduits of the monolith. The optional spacers are not taken into account in determining the density of the gel; in other words, in the case where spacers are present, the gel is considered to be located outside of the spacers.

On the other hand, if the silica gel contains third bodies such as fibres, microfibres, nanofibres, and particles or nanoparticles, the density considered is the density of the medium exterior to these third bodies and produced by the sol gel method itself.

The density may be measured using:
1. either porosimetry according to the BET method if the silica gel does not contain such third bodies;
2. or transmission electron microscopy followed by image analysis, on a section of the material if the silica gel contains such third bodies.

Advantageously, in the second embodiment, the preforms are preferably pyrolysable or hydrolysable yarns or fibres (e.g. segments or sections), for example carbon-based pyrolysable or hydrolysable yarns such as, in particular, carbon fibres, yarns made from polymer, polyolefin, polysulfone, polyurethane, polyacrylate and polymethacrylate, polyamide, polyimide, polyether or polyester, and derivatives thereof, which are typically occluded in the gel. The conduits resulting from the ablation of the preforms may extend in one portion of the material only, and be immersed or occluded there. Indeed, the shrinkage inherent in the drying of such silica gels is thus more easily accommodated, and stresses which can lead to their cracking are reduced. Further, the presence of large-sized macropores in multimodal gels enables easy convection of a fluid percolating between adjacent conduits. A compact stack of conduits can be produced in the material in order to promote the convective transfer of a fluid circulating in the material between the conduits and towards an outlet face.

The yarns or fibres, more particularly the segments of yarns, generally have a length between several micrometres and several centimetres, typically between one and ten millimetres. Advantageously these yarns have a length greater than the diameter of the final packing.

The yarns are typically statistically oriented in the direction of flow of the fluid, in other words from the inlet towards the outlet of the packing.

The yarns generally have a diameter less than 50 μm, more advantageously less than 10 μm, still more advantageously less than 5 μm.

The yarns can be covered with a spacer in order to avoid them touching in the packing and so that they do not produce points of weakness and preferential passages at these contact points. The spacer can be a layer of porous solid.

The present invention also relates to a packing that can be obtained by the method of the present invention.

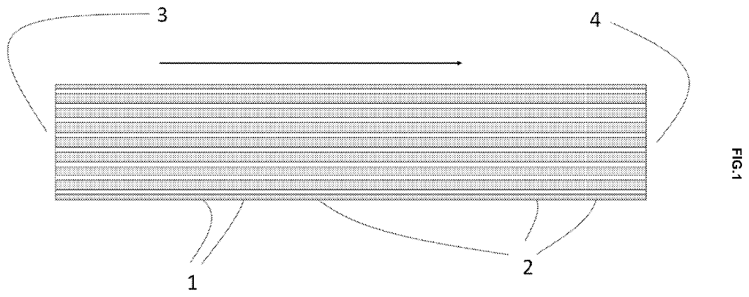

FIG. 1 shows schematically, viewed in axial section, a multi-capillary packing according to the invention comprising continuous conduits 2 extending axially between an inlet face 3 and an outlet face 4 in a porous mass 1 obtained by a sol gel method.

FIG. 2 shows schematically, viewed in axial section, a multi-capillary packing according to the invention comprising discontinuous conduits arranged in the form of segments 5 extending axially between an inlet face 3 and an outlet face 4 and occluded in a porous mass 1 obtained by a sol gel method.

Embodiments of the invention are illustrated in the following examples. These examples in no way limit the present invention.

### EXAMPLES

### Example 1

In this example, the precursor polymer fibres of the conduits are assembled into a bundle, the bundle is immersed in a precursor solution of a silica gel, which solution causes the gel around the fibre, then the fibres are eliminated by pyrolysis and combustion.

A monofilament of polyamide (of external diameter approximately 100 μm) is soaked in an aqueous solution containing 10% polyvinyl alcohol and 15% by weight glass microbeads supplied by Potters Ballotini having a particle size distribution with diameters between 40 and 70 μm. The monofilament is then dried. In this way, the outside of the polyamide filament is covered with silica gel microbeads which act as spacers, adhering to its surface through the action of the PVA which acts as glue.

The bundle is manufactured by assembling these filaments into a bundle of rectangular cross-section, of width 1700 μm, depth 250 μm and length 100 mm. This bundle is created by winding in a conduit precisely machined in a sheet of stainless steel 316 L, of dimensions 100 mm×20 mm×10 mm. The bundle of polyamide fibres is impregnated by a mixture of 25 ml tetraethoxysilane, 10.0 ml mineralised water and 0.35 ml 1N ammonia solution stirred beforehand until a single phase mixture is formed. The liquid must completely wet and fill the conduit as well as the packing. The packing is closed by a top cover consisting of a flat sheet of stainless steel of dimensions identical to those of the base steel sheet, screwed onto the latter, on which is previously deposited a thickness of approximately 5 micrometres of a paraffin melting at 90° C.

The mixture is left to polymerise and gel for 24 hours at 80° C.

The two ends of the packing thus formed are cut flush with the steel sheet so as to release the section of the packing.

The packing has a length of 100 mm.

The cover is removed after having brought the packing to a temperature of 95° C. so as to melt the paraffin, and the packing is vacuum dried at 2 kPa and at a temperature of 20° C. for 48 hours.

The resulting product is heated to 550° C. in an air atmosphere in order to convert it into a multi-capillary packing by burning off the polymer fibres.

Once cooled, the packing is re-closed on its upper part by a flat stainless steel sheet of the same dimensions, or cover, screwed on that containing the packing.

### Example 2

In this example, the precursor polymer fibres of the conduits are assembled into a bundle, the bundle is immersed in a precursor solution of a silica gel, which solution causes the gel around the fibre, then the fibres are eliminated by pyrolysis and combustion.

A monofilament of polyamide (of external diameter approximately 100 μm) is soaked in an aqueous solution containing 10% polyvinyl alcohol and 15% by weight glass microbeads supplied by Potters Ballotini having a particle size distribution with diameters between 40 and 70 μm. The monofilament is then dried. In this way, the outside of the polyamide filament is covered with glass microbeads which act as spacers, adhering to its surface through the action of the PVA which acts as glue.

The bundle is manufactured by assembling these filaments into a bundle of rectangular cross-section, of width 1700 μm, depth 250 μm and length 100 mm. This bundle is created by winding in a conduit precisely machined in a sheet of stainless steel 316 L, of dimensions 100 mm×20 mm×10 mm. The bundle of polyamide fibres is impregnated by a mixture of 25 ml tetraethoxysilane, 10.0 ml mineralised water and 0.35 ml 1N ammonia solution stirred beforehand until a single-phase mixture is formed, and 5 grams of mesoporous silica nanoparticles of particle diameter 20 nm and specific surface area 600 m²/g, reference 637246 from Sigma Aldrich. The liquid must completely wet and fill the conduit as well as the packing.

The packing is closed by a top cover consisting of a flat sheet of stainless steel of dimensions identical to those of the base steel sheet, screwed onto the latter, on which is previously deposited a thickness of approximately 5 micrometres of a paraffin melting at 90° C.

The mixture is left to polymerise and gel for 24 hours at 80° C.

The two ends of the packing are cut flush with the steel sheet so as to release the section of the packing.

The packing has a length of 100 mm.

The cover is removed after having brought the packing to a temperature of 95° C. so as to melt the paraffin, and the packing is vacuum dried at 2 kPa and at a temperature of 20° C. for 48 hours.

The resulting product is heated to 550° C. in an air atmosphere in order to convert it into a multi-capillary packing by burning off the polymer fibres.

Once cooled, the packing is re-closed on its upper part by a flat stainless-steel sheet of the same dimensions, or cover, screwed on that containing the packing.

### Example 3

In this example, precursor polymer fibres of the conduits are assembled into a bundle, the bundle is immersed in a precursor solution of a silica gel, which solution causes the gel around the fibre, then the fibres are eliminated by pyrolysis and combustion.

A monofilament of polyamide (of external diameter approximately 100 μm) is soaked in an aqueous solution containing 10% polyvinyl alcohol and 15% by weight glass microbeads supplied by Potters Ballotini having a particle size distribution with diameters between 40 and 70 μm. The monofilament is then dried. In this way, the outside of the polyamide filament is covered with glass microbeads which act as spacers, adhering to its surface through the action of the PVA which acts as glue.

The bundle is manufactured by assembling these filaments into a bundle of rectangular cross-section, of width 1700 μm, depth 250 μm and length 100 mm. This bundle is created by winding in a conduit precisely machined in a sheet of stainless steel 316 L, of dimensions 100 mm×20 mm×10 mm. The bundle of polyamide fibres is impregnated by a mixture of 25 ml tetraethoxysilane, 10.0 ml mineralised water and 0.35 ml 1N ammonia solution stirred beforehand until a single-phase mixture is formed, and 1 g of potassium titanate fibres of diameter 0.2 μm, length 18 μm, marketed under the trade name TISMO D by Otsuka Chemical Co, Ltd. The liquid must completely wet and fill the conduit as well as the packing. The packing is closed by a top cover consisting of a flat sheet of stainless steel of dimensions identical to those of the base steel sheet, screwed onto the latter, on which is previously deposited a thickness of approximately 5 micrometres of a paraffin melting at 90° C.

The mixture is left to polymerise and gel for 24 hours at 80° C.

The two ends of the packing thus formed are cut flush with the steel sheet so as to release the section of the packing.

The packing has a length of 100 mm.

The cover is removed after having brought the packing to a temperature of 95° C. so as to melt the paraffin, and the packing is vacuum dried at 2 kPa and at a temperature of 20° C. for 48 hours.

The resulting product is heated to 550° C. in an air atmosphere in order to convert it into a multi-capillary packing by burning off the polymer fibres.

Once cooled, the packing is re-closed on its upper part by a flat stainless-steel sheet of the same dimensions, or cover, screwed on that containing the packing.

### Example 4

In this example, precursor polymer fibres of the conduits are assembled into a bundle, the bundle is immersed in a precursor solution of a silica gel, which solution causes the gel around the fibre, then the fibres are eliminated by pyrolysis and combustion.

A monofilament of polyamide (of external diameter approximately 100 μm) is soaked in an aqueous solution containing 10% polyvinyl alcohol and 15% by weight glass microbeads supplied by Potters Ballotini having a particle size distribution with diameters between 40 and 70 μm. The monofilament is then dried. In this way, the outside of the polyamide filament is covered with glass microbeads which act as spacers, adhering to its surface through the action of the PVA which acts as glue.

The bundle is manufactured by assembling these filaments into a bundle of rectangular cross-section, of width 1700 μm, depth 250 μm and length 100 mm. This bundle is created by winding in a conduit precisely machined in a sheet of stainless steel 316 L, of dimensions 100 mm×20 mm×10 mm. The bundle of polyamide fibres is impregnated by a mixture of 25 ml tetramethoxysilane and 20.0 ml mineralised water, stirred beforehand until a single-phase mixture is formed. The liquid must completely wet and fill the conduit as well as the packing.

The packing is closed by a top cover consisting of a flat sheet of stainless steel of dimensions identical to those of the base steel sheet, screwed onto the latter, on which is previously deposited a thickness of approximately 5 micrometres of a paraffin melting at 90° C.

The mixture is left to polymerise and gel for 24 hours at 80° C.

The two ends of the packing thus formed are cut flush with the steel sheet so as to release the section of the packing.

The packing has a length of 100 mm.

The cover is removed after having brought the packing to a temperature of 95° C. so as to melt the paraffin, and the packing is vacuum dried at 2 kPa and at a temperature of 20° C. for 48 hours.

The resulting product is heated to 550° C. in an air atmosphere in order to convert it into a multi-capillary packing by burning off the polymer fibres.

Once cooled, the packing is re-closed on its upper part by a flat stainless-steel sheet of the same dimensions, or cover, screwed on that containing the packing.

### Example 5

In this example, precursor polymer fibres of the conduits are assembled into a bundle, the bundle is immersed in a precursor solution of a silica gel, which solution causes the gel around the fibre, then the fibres are eliminated by pyrolysis and combustion.

A monofilament of polyamide (of external diameter approximately 100 μm) is soaked in an aqueous solution containing 10% polyvinyl alcohol and 15% by weight glass microbeads supplied by Potters Ballotini having a particle size distribution with diameters between 40 and 70 μm. The monofilament is then dried. In this way, the outside of the polyamide filament is covered with glass microbeads which act as spacers, adhering to its surface through the action of the PVA which acts as glue.

The bundle is manufactured by assembling these filaments into a bundle of rectangular cross-section, of width 1700 μm, depth 250 μm and length 100 mm. This bundle is created by winding in such a conduit precisely machined in a sheet of titanium (ASTM grade 2) that is 100 mm×20 mm×10 mm.

The bundle of polyamide fibres is impregnated with a mixture of 1.6 g of Brij 56 (commercial surfactant), 1 g dodecane, 4 g tetramethoxysilane, and 2 g of 0.05N HCl in deionised water. TEOS, dodecane and Brij are mixed at 50° C. until the mixture is homogeneous. The 0.5N acid (HCl) is then added under vigorous stirring. The mixture is poured into the conduit bearing the fibres.

The packing is closed by a top cover consisting of a flat sheet of titanium (ASTM grade 2) of dimensions identical to those of the base titanium sheet, screwed onto the latter, on which is previously deposited a thickness of approximately 5 micrometres of a paraffin melting at 90° C.

The mixture is left to polymerise and gel for 24 hours at 20° C.

The two ends of the packing are cut flush with the titanium sheet so as to release the section of the packing.

The packing has a length of 100 mm.

The cover is removed, and the packing is vacuum dried at 2 kPa and at a temperature of 20° C. for 48 hours.

The resulting product is heated to 550° C. in an air atmosphere in order to convert it into a multi-capillary packing by burning off the polymer fibres.

Once cooled, the packing is re-closed on its upper part by a flat sheet of titanium (ASTM grade 2) of the same dimensions, or cover, screwed on that containing the packing.

Once cooled, the packing is re-closed on its upper part by a flat stainless-steel sheet of the same dimensions, or cover, screwed on that containing the packing.

### Example 6

A preform of the conduits of the monolith is produced by producing a bundle composed of segments of carbon fibres of diameter 4.8 μm and length five millimetres.

The bundle of these segments or needles is then inserted at the bottom of a recess of width 2.0 mm, depth 2 mm and length 75 mm hollowed out in a 20×10×75 mm sheet of stainless steel 316 L so as to produce a stack of naturally packed needles aligned along the length of the conduit. A flat cover is prepared in a 20×10×75 mm sheet of PTFE.

The bundle is produced with a length of 75 mm.

A silicic monolith is synthesised from tetraethoxysilane (TEOS, Aldrich 99%), polyethylene oxide (PEO, molar mass=10,000, Aldrich 99%), nitric acid (68%, Aldrich) and NH4OH (analytical purity, Aldrich).

A 250 mL Erlenmeyer flask is placed in an ice bath at 0° C. with a magnetic bar. Then, demineralised water (36 g, 2 mol) and nitric acid (68% HNO3, 3.60 g, 38.84 mmol) are added and stirred at 500 rpm for 15 min. Then, PEO (4.79 g PEO including 0.11 mol unit EO) is added and the mixture is stirred for one hour at 700 rpm in order that all the PEO is dissolved. TEOS (37.70 g, 0.18 mol) is then added and the mixture is stirred for one hour. The transparent solution obtained is then poured using a 10 mL pipette in the core of the previously obtained bundle of segments, stored beforehand in a dry environment at 0° C. before filling. The bar is then placed in an oven under a saturated atmosphere of water vapour at 40° C. for 72 hours. The PTFE cover is removed.

The bar is immersed in a 2 L beaker with 1500 mL of demineralised water at ambient temperature for 1 h. The monolith is then washed four times in the same way, by immersion in the demineralised water (500 mL, 1 h) until a neutral pH is obtained. The monolith is then subjected to a base treatment. It is then immersed in 400 mL of an ammonia solution (0.1 M) in a polypropylene flask (500 mL). The flask is then placed in an oven at 40° C. for 24 hours.

The recovered monolith is rinsed using a wash bottle with distilled water, dried at ambient temperature for 48 h and at 40° C. for 24 h on a flat surface.

It is calcined at 650° C. under air for 24 hours (ramp 1° C. min-1).

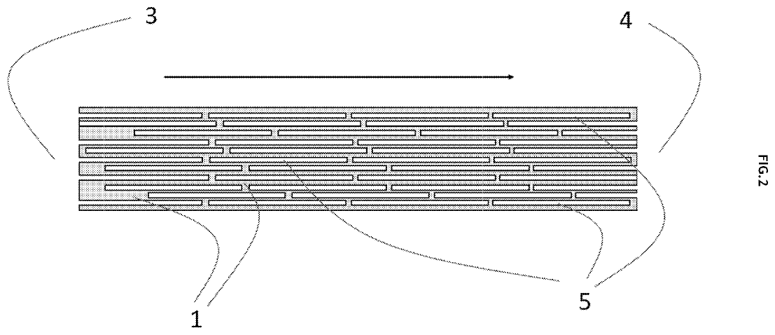

A flat cover is prepared in a 20×10×75 mm sheet of stainless steel (FIGS. 19 and 20).

The cover is repositioned with a PEEK seal at 340° C. and cooled.

The end pieces (FIGS. 22 and 23) are fixed (FIG. 24) on the column and the assembly is sealed by a film of two-component epoxy glue.

### BIBLIOGRAPHY

[1] K Nakanishi, Phase separation in silica sol-gel system containing polyacrylic acid, Journal of non-crystalline Solids 139 (1992), 1-13 and 14-24;
[2] K. Nakanishi, Phase separation in Gelling Silica-Organic Polymer Solution: Systems Containing Poly(sodium styrenesulfonate), J. Am. Ceram. Soc. 74 (10) 2518-2530-30 (1991);
[3] N. Ishizuka, Designing monolithic double pore silica for high-speed liquid chromatography, Journal of Chromatography A, 797 (1998), 133-137.

1. Method for manufacturing a multi-capillary packing from a substrate of ablative preforms, each preform being suitable for forming, during its ablation, a conduit enabling the convection of a fluid in said packing, said method comprising the following steps:
(a) assembling the ablative preforms in the form of at least one bundle;
(b) creating a gel between the ablative preforms of the bundle by hydrolysis of an organometallic precursor in the presence of a quantity of water not exceeding ten times the stoichiometric quantity required for complete hydrolysis of said organometallic precursor;
(c) ablating the preforms, preferably by pyrolysis, oxidation, vaporisation, melting and drainage, mechanical extraction or chemical attack, so as to form a plurality of conduits in the gel.

2. Method according to claim 1, further comprising a drying step between steps (b) and (c) or after step (c).

3. Method according to claim 2, wherein the drying is carried out under vacuum at ambient temperature.

4. Method according to one of the preceding claims, wherein the organometallic precursor is an organometallic alkaloid, organometallic acetate, organometallic carboxylate, organometallic halide, organometallic nitrate, organometallic alkanoate, organometallic acyloxide, or one of the mixtures thereof.

5. Method according to one of the preceding claims, wherein the organometallic precursor is chosen from the organometallic derivatives of silicon, aluminium, zirconium, titanium, a rare earth such as yttrium, cerium or lanthanum, boron, iron, magnesium, calcium, strontium, barium, germanium, phosphorus, lithium, potassium, sodium, niobium, copper, or one of the mixtures thereof.

6. Method according to one of the preceding claims, wherein the organometallic precursor is tetramethoxysilane or tetraethoxysilane.

7. Method according to one of the preceding claims, wherein the gel has a pore volume of between 20% and 90% by volume of the gel, advantageously between 40% and 65% by volume of the gel.

8. Method according to one of the preceding claims, wherein the preforms comprise yarns of polyamide, polyolefin, polyacrylate, polymethacrylate, polysulfone, polyurethane, polyimide, polyether or polyester yarns.

9. Method according to claim 8, wherein the polyester yarns are hydrolysable polyester yarns.

10. Method according to one of the preceding claims, wherein the ablative preforms are covered with a porous granular substance before assembling in bundle form.

11. Method according to one of the preceding claims, wherein the ablative preforms are shaped into segments occluded in the body of the packing.

12. Method according to one of the preceding claims, wherein the gel is a silica gel.

13. Method according to claim 12, wherein the gel is a multimodal silica gel and wherein the quantity of water does not exceed six times the stoichiometric quantity required for complete hydrolysis of said organometallic precursor, preferably wherein the quantity of water does not exceed five times the stoichiometric quantity required for a complete hydrolysis of said organometallic precursor, still more preferably wherein the quantity of water does not exceed four times the stoichiometric quantity required for complete hydrolysis of said organometallic precursor.

14. Multi-capillary packing that can be obtained by the method of one of the preceding claims.
